(19) United States
(12) Patent Application Publication
(10) Pub. No.: US 2008/0068288 A1
(43) Pub. Date: Mar. 20, 2008

(54) Foldable display screens

(76) Inventor: Paul Arthur Henkel, Indialantic, FL (US)

Correspondence Address: LOUIS L. DACHS, 1794 PALSIADES DRIVE, PACIFIC PALISADES, CA, 90272, US

(21) Appl. No.: 11/521,723

(22) Filed: Sep. 15, 2006

(51) Int. Cl. G09G 5/00

(52) U.S. Cl. 345/1.3

(57) ABSTRACT

The invention is a foldable set of six displays screens in two rows of three screens. The top and bottom middle screens are hinged together. First side of upper and lower screens are hinged to the one side of the upper and lower middle screens. The second side of the upper and lower screens are attached to the upper and lower middle screens by means of double hinges.

### BACKGROUND OF THE INVENTION

1. Field of the Invention

The invention relates to the field of display screens for computers and the like and, in particular, to a multiple display screen assembly that is foldable in to a small package for storage or transport.

2. Description of Related Art

Providing a series of foldable display screens is far from new. For example, all laptop or notebook computers have a computer screen that can be folded over onto the key board for storage purposes. However, it becomes more of a problem when one wants multiple display screens connected to a computer. This issue was addressed in U.S. Pat. No. 6,302,612 Pivotally Extensible Display Device by C. B. Fowler, et al. Here a smaller display screen is pivotally attached to the top of the main screen of a laptop computer. A smaller screen is pivotally attached to each side of the main display screen. For storage, the top and two side screens are folded over onto the main screen and the main screen is folded on top of the key board.

U.S. Pat. No. 6,643,124 Multiple Display Portable Computer Devices, by P. J. Walk, discloses a notebook computer also having multiple screens. In this case, the main body of the computer includes a key board pivotally connected to a second part having a display screen. Pivotally attached to the second part is a second display screen. Attached to the second display screen is a third display screen. To store the computer, the key board is folded over onto the first screen. The Third screen is folded onto the second screen. Thereafter the folded second and third screens are folded over onto the now folded first screen and key board.

None of these devices allow for a large number of display screens, six to be exact, of equal size to be folded and stored in a small compact package.

Thus, it is a primary object of the invention to provide a display device having six display screens that are foldable into a small package.

It is another primary object of the invention to provide a display device having six display screens that are foldable into a small package wherein all the display screens are of equal size.

It is a further object of the invention to provide a display device having six display screens that are foldable into a small package that are lockable in the extended position.

### SUMMARY OF THE INVENTION

The invention is a display screen assembly. In detail the invention includes first and second display screens, each having top, bottom edges and first and second side edges, the bottom edge of the first screen is mounted to the top edge of the second screen by a first hinge. Third and fourth display screens having first and second sides and top, bottom and first and second side edges are connected to their first edges of said first and second screens, respectively, by second and third hinges. Finally, fifth and sixth screens having first and second sides and top, bottom and first and second side edges are connected to said second side edges of said first and second screens, respectively, by first and second double hinges, respectively. Locking assemblies are provided to secure the screens together.

Thus the third and fourth screens can be folded over on to the first and second screens and the fifth and sixth screens can thereafter folded over onto the folded third and fourth screens and, finally the first third and fifth screens can thereafter be folded over onto the first third and fifth screens. In this stored condition, the screen assembly can easily be transported or stored in a compact space

The novel features which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF THE DRAWINGS

FIG. 1 is a front view of the six display screens in the extended position.

FIG. 2 is a rear view of the six screens in the extended position.

FIG. 3 is a top view of the six screens shown in FIG. 1.

FIG. 4 is a cross-sectional view of a locking mechanism used to lock the screens together when in the extended position.

FIG. 5 is a top view similar to FIG. 3 illustrating the first step in folding the six screens.

FIG. 6 is a top view similar to FIG. 5 illustrating the second step in folding the six screens.

FIG. 7 is a top view similar to FIG. 6 illustrating the third step in folding the six screens.

FIG. 8 is a side view of FIG. 7 illustrating the final step of folding the six screens.

### DESCRIPTION OF THE PREFERRED EMBODIMENT

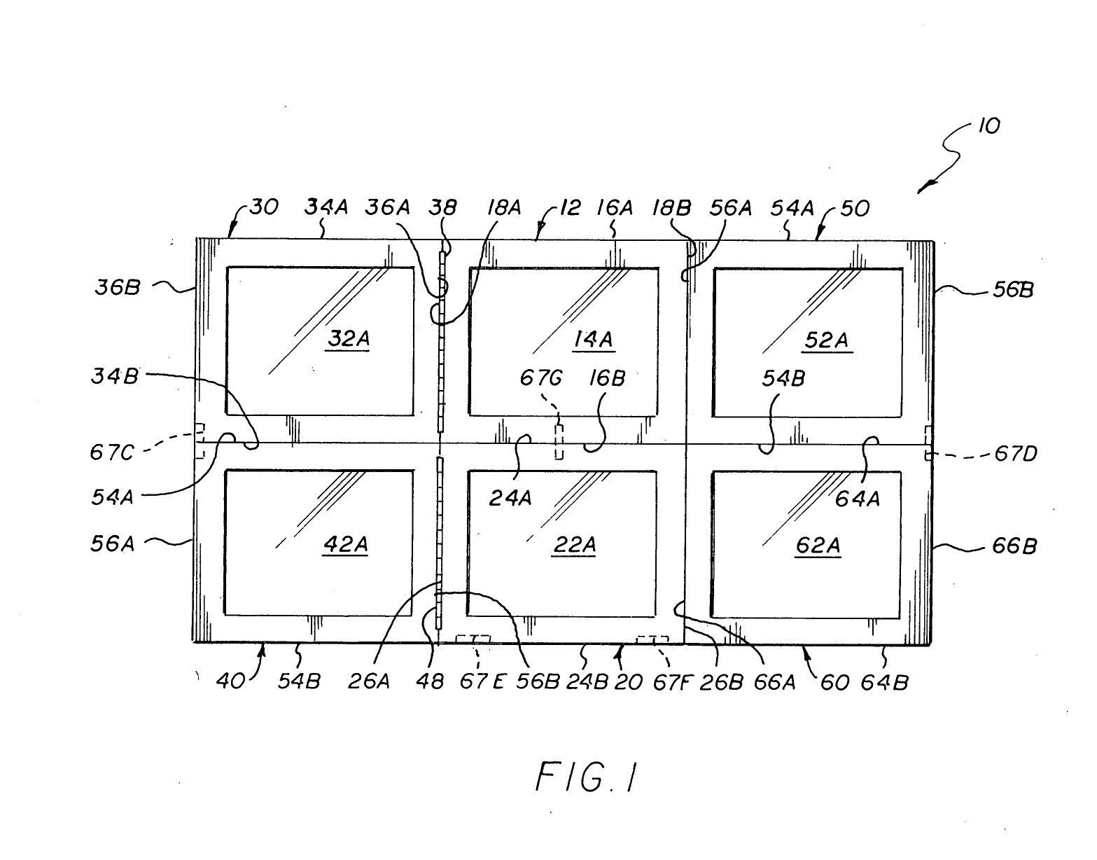

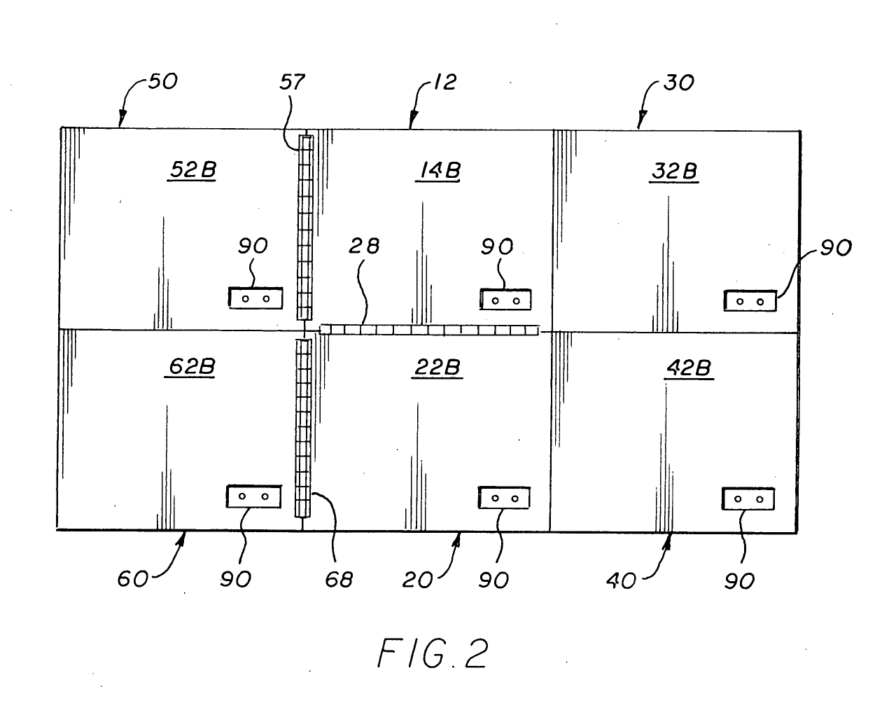

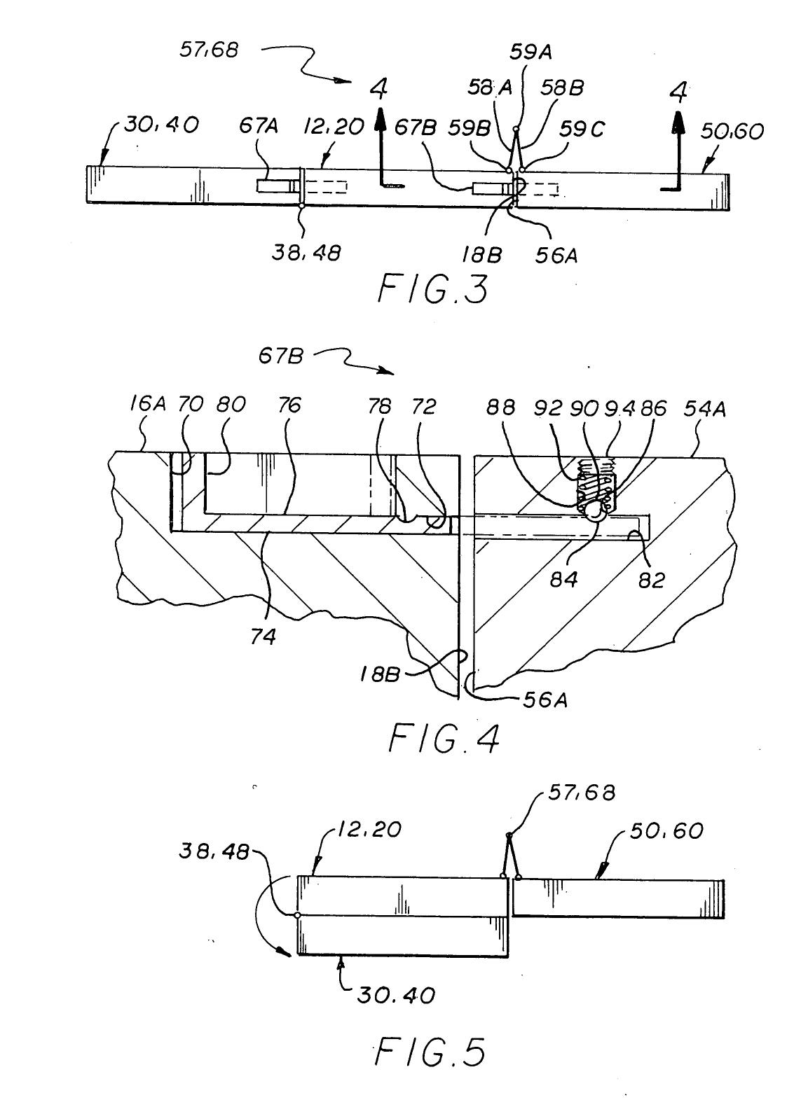

Referring to FIGS. 1-3, the display screen assembly, generally indicated by numeral 10, includes upper middle screen 12, having front and rear surfaces 14A and 14B, upper and lower edges 16A and 16B and side edges 18A and 18B. A lower middle screen 20 includes front and rear surfaces 22A and 22B, upper and lower edges 24A and 24B and side edges 26A and 26B. The lower middle screen 20 is rotatably coupled by its upper edge 26A to the lower edge 18B of screen 12 by a hinge 28 located in proximity to the rear surfaces 14B and 22B, such that rear surface 14B of the upper middle screen 12 is in contact with the rear surface 22B of the lower middle screen 20.

An upper first side screen 30 includes front and rear surfaces 32A and 32B, upper and lower edges 34A and 34B and side edges 36A and 36B. The first side edge 36A is coupled to the first aide edge 18A by means of hinge 38 located in proximity to the front surfaces 14A and 32A. A lower first side screen 40 includes front and rear surfaces 42A and 42B, upper and lower side edges 44A and 44B and first and second side edges 46A and 46B. The first side edge 46A of the side screen 40 is coupled to the first side edge 26A of the screen 20 by means of hinge 48 located in proximity to the surfaces 42A and 22A.

An upper second side screen 50 includes front and rear surfaces 52A and 52B, upper and lower edges 54A and 54B and side edges 56A and 56B. The first side edge 56A is coupled to the first aide edge 18B by means of double hinge assembly 57 located in proximity to the rear surfaces 14B and 52B. The hinge assembly 57 includes two plates 58A and 58B coupled together by a hinge 59A and to hinge 59B mounted edge 18B of screen 12 and by a hinge 59C to the side edge 56A of screen 50. A lower second side screen 60 includes front and rear surfaces 62A and 62B, upper and lower side edges 64A and 64B and first and second side edges 66A and 66B. The first side edge 66A of the side screen 60 is coupled to the second side edge 26B of the screen 20 by means of double hinge assembly 68 (identical to hinge assembly 57) located in proximity to the surfaces 62B and 22B.

Still referring to FIGS. 1-3 and additionally to FIG. 4, the screens 12, 20, 30, 40, 50, and 60 are all locked in the extended position by a series of identical locking assemblies 67A, 67B, 67C, 67D, 67E, 67F and 67G. For purposes of illustration locking assembly 66B will be described in detail. Locking assembly 67B includes a slot 70 in the edge 16A of the screen 12. A round hole 72 extends from the slot 70 to the edge 18B. Mounted in the slot 70 is a locking member 74 having a rod portion 76 movably mounted in the hole 72 having a circular indentation 78 at one end and a tab 80 extending upward into the slot 70. The tab 80 is sized to slidably engage the walls of the slot 70 such that the rod portion can not rotate.

A hole 82 aligned with the hole 72 extends from the side edge 36A of the screen 20 and includes a ball detent assembly 84. The ball detent assembly 84 includes a small diameter hole 86 that extends from upper edge 54A having a counter bore 88. A ball 90 is biased by a spring 92 mounted in the counter bore 88 and is retained by threaded plug 94. The ball 90 is sized such that it extends partially through the hole 86 and into the hole 82. Thus when tap 80 is pushed to toward screen 20, the rod portion 76 enters the hole 82, the ball 90 is pushed back until the indentation 78 becomes aligned. It then, because it is spring biased engages the indentation 78, locking the rod 76 in place. This screen 12 is locked to screens 30 and 50, and screen 20 is locked to screens 40 and 60, screen 40 is locked to screen 20 and screen 50 is locked to screen 60. It should be noted that other types of locking systems could be used.

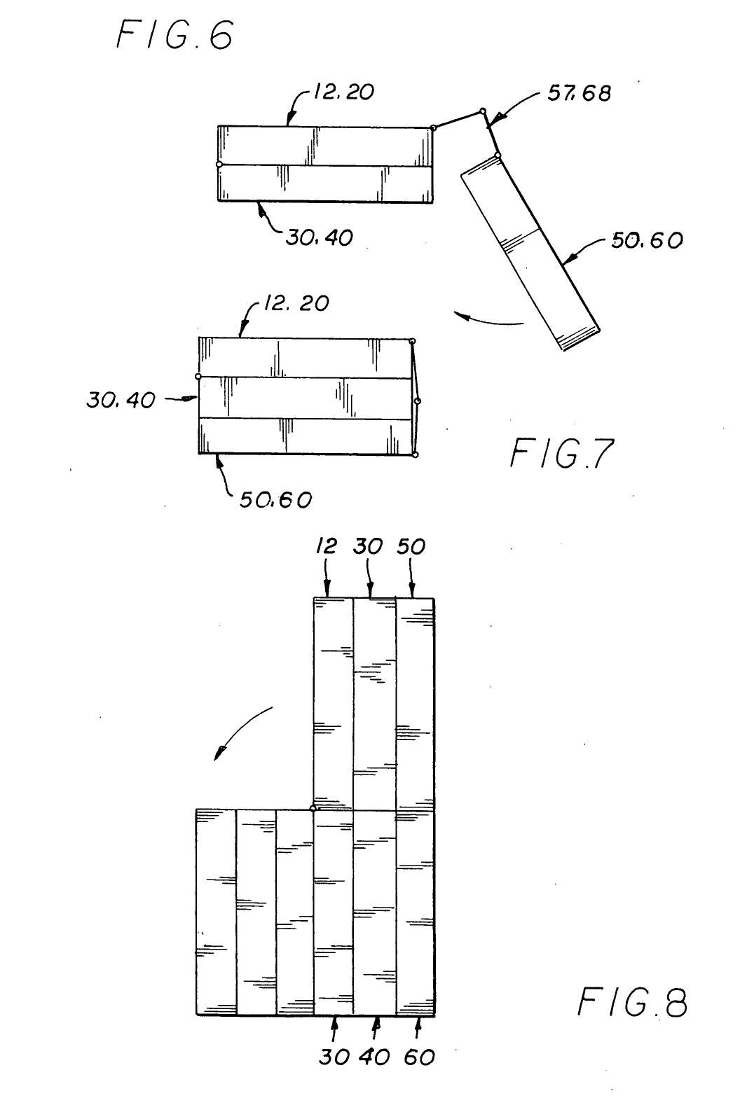

Referring to FIG. 4-7 To fold up the screen assembly 10, all the locking assemblies must first be unlocked by moving the tabs 80 such that the rods 76 are removed from the holes 82. Thereafter, screens 30 and 40 are fold ever onto sides 14A of screen 12 and screen 40 is folded over on to side 22A of screen 20. Thereafter, screens 50 and 60 are folded over on the rear sides 52B and 62B of the screens 30 and 40. Note that the hinge assemblies 57 and 68 allow for the screens 50 and 60 to translate forward prior to rotation over the screens 30 and 40. Final the fold screens 12, 20 and 40 are rotated about hinge 28 such that side 18A of screen 13 is against The screens can be electrically wired together or plugged together after expansion. Note electrical connector panels 90 on each screen.

Thus it can be seen that the six screens and be extended and folded up into a portable size with ease. Again, it should be noted that locking assemblies described were for purposes of illustration only and many other types of locking devices could be used.

While the invention has been described with reference to a particular embodiment, it should be understood that the embodiment is merely illustrative as there are numerous variations and modifications which may be made by those skilled in the art. Thus, the invention is to be construed as being limited only by the spirit and scope of the appended claims.

### INDUSTRIAL APPLICABILITY

The invention has applicability to the computer industry.

1. A display assembly comprising:
first and second display screens, each having top, bottom sides and first and second sides, said bottom of said first screen mounted to said top side of said second screen by a first hinge;
third and fourth display screens having first sides connected to said first sides of said first and second screens, respectively, by second and third hinges; and
fifth and sixth screens having first sides connected to said second sides of said first and second screens, respectively, by first and second double hinges, respectively;
such that said third and fourth screens can be folded over on to said first and second screens and said fifth and sixth screens can thereafter be folded over said third and fourth screens and said first third and fifth screens can thereafter be folded over onto said first third and fifth screen can be folded over on said second fourth and sixth screens.

2. The display assembly as set forth in claim 1 comprising locking means to lock said first, second, third, fourth, fifth and sixth screens in the extended position.

3. A display system comprising a foldable set of six displays screens in two rows of three screens each; the top and bottom middle screens hinged together; the top edge of said bottom middle screen hinged to said bottom edge of said top middle screen, upper and lower first side screens hinged to the one side of said upper and lower middle screens; and upper and lower second side screens coupled to the second sides of said upper and lower middle screens by means of a double hinges.

4. The display system as set forth in claim 3 comprising means to lock said screens together.
